(19) United States
(12) Patent Application Publication
(10) Pub. No.: US 2025/0366503 A1
(43) Pub. Date: Dec. 4, 2025

(54) NOVEL GLUCOPYRANOSIDE COMPOSITIONS FOR SWEETNESS ENHANCEMENT

(71) Applicant: International Flavors & Fragrances Inc., New York, NY (US)

(72) Inventors: Zhichun Shang, Nanjing (CN); Li Chen, Belle Mead, NJ (US); Melanie Croce, Union Beach, NJ (US); Qingxi Su, Holmdel, NJ (US); Diane Klaser Cheng, Highland Park, NJ (US)

(21) Appl. No.: 18/875,268

(22) PCT Filed: Jun. 29, 2023
(86) PCT No.: PCT/US2023/069353

§ 371 Date: Dec. 16, 2024

(30) Foreign Application Priority Data
Jul. 4, 2022 (WO) PCT/CN2022/103589

(51) Int. Cl. A23L 27/00; A23L 27/10; A23L 27/20; A23L 27/30

(52) U.S. Cl. CPC A23L 27/88; A23L 27/10; A23L 27/2052; A23L 27/32; A23L 27/33; A23L 27/36; A23L 27/37

(57) ABSTRACT

The use of glucopyranoside compounds to enhance the sweetness of a sweetness modifier and to decrease the amount of a sweetness modifier used in a consumable is provided.

### STATUS OF RELATED APPLICATION

This application is a 371 of International Application No. PCT/US2023/069353, filed Jun. 29, 2023, which claims priority to Chinese Provisional Application No. PCT/CN2022/103589, filed Jul. 4, 2022, the content hereby incorporated by reference as if set forth in its entirety.

### BACKGROUND OF INVENTION

Reducing sugar content in food and beverages has become a necessity in the food industry. Food and beverage manufacturers generally use non-caloric, high-intensity sweetness modifiers, such as rebaudioside A (Reb A), aspartame, saccharin, glycosylated steviol glycosides, etc., to partially or completely replace sugar. However, these sweetness modifiers may exhibit undesirable taste attributes such as delayed onset of sweetness, bitter and astringent aftertaste, and lack of body and mouthfeel. Consequently, sweetness enhancers have become valuable tools, which reduce the use of sugar and/or sweetness modifiers, in achieving the desired sweetness intensity and mouthfeel with reduced off-taste.

Sweetness enhancers have been described in the prior art. For example, WO 2013/143822 teaches the use of adenosine as sweetness enhancer for certain sugars; EP 2606747 describes the use of deoxycholic acid or a derivative thereof for enhancing the sweetness of consumables; WO 2013/077668 describes the sweetness enhancing effect of a glycan or glycopeptide derived from soy sauce; WO 2012/107203 teaches the use of nobiletin or a derivative or a hydrate thereof as a sweetener or sweetness enhancer; WO 2009/023975 describes the use of iso-mogroside V as a sweetener and sweetness enhancer; US 2008/0242740 teaches aroma compositions of alkamides with hesperetin and/or 4-hydroxydihydrochalcones for enhancing sweet sensory impressions; and WO 2007/014879 and WO 2007/107596 respectively teach the use of hesperetin and 4-hydroxydihydrochalcones for enhancing the sweet taste of a sweet-tasting substance or sweet olfactory impression of a flavoring.

### SUMMARY OF THE INVENTION

This invention provides a method of enhancing the sweetness of a sweetness modifier by adding an olfactory effective amount of a glucopyranoside compound represented by Formula I to the sweetness modifier:

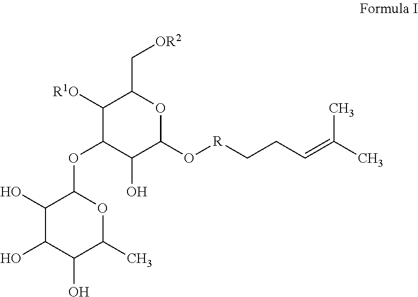

wherein one of R¹ and R² represents hydrogen and the other one thereof represents

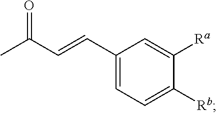

R^{a} and R^{b} are independently selected from the group consisting of hydrogen and a hydroxy group; and wherein R represents a C₄ alkenyl group.

In another embodiment, the present invention is directed to a composition comprising a sweetness modifier and an olfactory effective amount of the glucopyranoside compound described above.

In another embodiment, the present invention is directed to a consumable comprising a sweetness modifier and an olfactory effective amount of the glucopyranoside compound described above.

These and other embodiments of the present invention will be apparent by reading the following specification.

### DETAILED DESCRIPTION OF THE INVENTION

In the present invention, Formula I can be illustrated by, for example, but not limited to, the following structures.

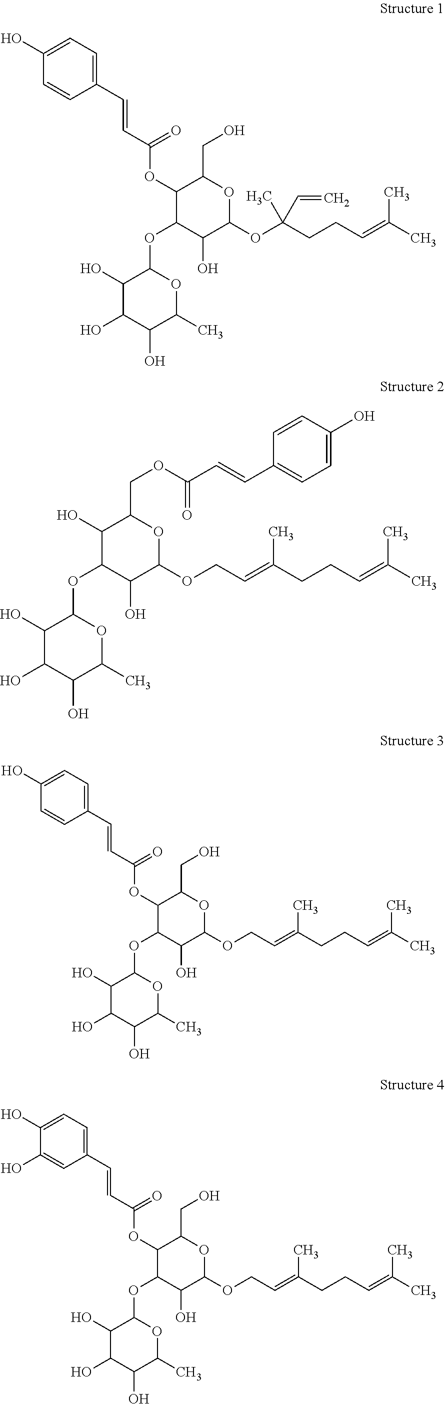 [SMILES: C=CC(C)(CCC=C(C)C)OC1OC(CO)C(OC(=O)/C=C/c2ccc(O)cc2)C(OC2OC(C)C(O)C(O)C2O)C1O ; CC(C)=CCC/C(C)=C/COC1OC(COC(=O)/C=C/c2ccc(O)cc2)C(O)C(OC2OC(C)C(O)C(O)C2O)C1O ; CC(C)=CCC/C(C)=C/COC1OC(CO)C(OC(=O)/C=C/c2ccc(O)cc2)C(OC2OC(C)C(O)C(O)C2O)C1O ; CC(C)=CCC/C(C)=C/COC1OC(CO)C(OC(=O)/C=C/c2ccc(O)c(O)c2)C(OC2OC(C)C(O)C(O)C2O)C1O]

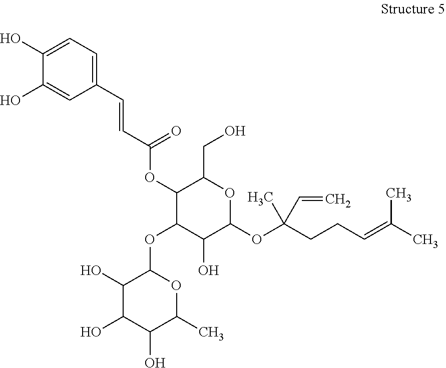 [SMILES: C=CC(C)(CCC=C(C)C)OC1OC(CO)C(OC(=O)/C=C/c2ccc(O)c(O)c2)C(OC2OC(C)C(O)C(O)C2O)C1O]

This present invention is directed to a method of enhancing the sweetness of a sweetness modifier by adding an olfactory effective amount of a glucopyranoside compound represented by Formula I to the sweetness modifier.

In one embodiment, the present invention is directed to a method of enhancing the sweetness of a sweetness modifier by adding an olfactory effective amount of a glucopyranoside compound selected from the group consisting of Structure 1, Structure 2, Structure 3, Structure 4, Structure 5, and a mixture thereof to the sweetness modifier.

In another embodiment, the present invention is directed to a method of enhancing the sweetness of a sweetness modifier by adding an olfactory effective amount of a lipedoside B-IIIb and ligurobustoside E mixture to the sweetness modifier.

In another embodiment, the present invention is directed to a method of enhancing the sweetness of a sweetness modifier by adding an olfactory effective amount of a lipedoside B-IIIb and ligurobustoside E mixture to the sweetness modifier, wherein lipedoside B-IIIb and ligurobustoside E have a weight ratio of from about 0.2 to 13.

In another embodiment, the present invention is directed to a composition comprising a sweetness modifier and an olfactory effective amount of the glucopyranoside compound represented by Formula I.

In another embodiment, the present invention is directed to a composition comprising a sweetness modifier and an olfactory effective amount of a glucopyranoside compound selected from the group consisting of Structure 1, Structure 2, Structure 3, Structure 4, Structure 5, and a mixture thereof.

In another embodiment, the present invention is directed to a composition comprising a sweetness modifier and an olfactory effective amount of a lipedoside B-IIIb and ligurobustoside E mixture.

In another embodiment, the present invention is directed to a composition comprising a sweetness modifier and an olfactory effective amount of a lipedoside B-IIIb and ligurobustoside E mixture, wherein lipedoside B-IIIb and ligurobustoside E have a weight ratio of from about 0.2 to 13.

In another embodiment, the present invention is directed to a consumable comprising a sweetness modifier and an olfactory effective amount of the glucopyranoside compound represented by Formula I.

In another embodiment, the present invention is directed to a consumable comprising a sweetness modifier and an olfactory effective amount of a glucopyranoside compound selected from the group consisting of Structure 1, Structure 2, Structure 3, Structure 4, Structure 5, and a mixture thereof.

In another embodiment, the present invention is directed to a consumable comprising a sweetness modifier and an olfactory effective amount of a lipedoside B-IIIb and ligurobustoside E mixture.

In another embodiment, the present invention is directed to a consumable comprising a sweetness modifier and an olfactory effective amount of a lipedoside B-IIIb and ligurobustoside E mixture, wherein lipedoside B-IIIb and ligurobustoside E have a weight ratio of from about 0.2 to 13.

In another embodiment, the above glucopyranoside compound is provided as a Ligustrum robustum (Roxb.) Blume leaf extract.

As used herein, the term “alkenyl” means a linear or branched unsaturated, aliphatic hydrocarbon containing at least one carbon-carbon double bond. The term “a” or “an” is understood to mean one or more. The term “a compound” is understood to mean one or more of the glucopyranoside compounds represented by Formula I.

It is intended herein that the compounds described herein include isomeric mixtures of such compounds, as well as those isomers that may be separated using techniques known to those having skill in the art. Suitable techniques include chromatography such as high performance liquid chromatography, referred to as HPLC, particularly silica gel chromatograph, and gas chromatography trapping known as GC trapping. Yet, commercial versions of such products are mostly offered as mixtures. In the present invention, Structure 1 represents, for example, lipedoside B-IIa (CAS No. 156979-57-6); lipedoside B-IIb (CAS No. 157085-47-7); lipedoside B-IIIa (CAS No. 157085-444); lipedoside B-IIIb (CAS No. 15708548-8); β-D-glucopyranoside, 1-ethenyl-1,5-dimethyl-4-hexenyl 3-O-(6-deoxy-α-L-mannopyranosyl)-, 4-[(2E)-3-(4-hydroxyphenyl)-2-propenoate](CAS No. 190896-33-4); or a mixture thereof. Structure 2 represents, for example, ligurobustoside E (CAS No. 189276-30-0). Structure 3 represents, for example, ligurobustoside C (CAS No. 176703-94-9) and ligurobustoside D (CAS No. 176779-11-6). Structure 4 represents, for example, ligurobustoside B (CAS No. 176703-93-8). Structure 5 represents, for example, (2R,3R,4R,5R,6S)-6-((3,7-dimethylocta-1,6-dien-3-yl)oxy)-5-hydroxy-2-(hydroxymethyl)-4-(((2S,3R,4R,5R,6S)-3,4,5-trihydroxy-6-methyltetrahydro-2H-pyran-2-yl)oxy)tetrahydro-2H-pyran-3-yl (E)-3-(3,4-dihydroxyphenyl)acrylate (“CPD5”), a compound is now identified for the first time. In addition, ligurobustoside K (CAS No. 189276-67-3), ligurobustoside I (CAS No. 185382-42-7) and (2R,3R,4R,5R,6R)-6-(((E)-3,7-dimethyl-5-oxoocta-3,6-dien-1-yl)oxy)-5-hydroxy-2-(hydroxymethyl)-4-(((2S,3R,4R,5R,6S)-3,4,5-trihydroxy-6-methyltetrahydro-2H-pyran-2-yl)oxy)tetrahydro-2H-pyran-3-yl (E)-3-(4-hydroxyphenyl)acrylate (“ ”CPD6”), a compound newly identified by the present invention, are also found to provide mild sweetness and sugary mouthfeel enhancement.

In the present invention, the glucopyranoside compounds of Formula I have been found to possess an unexpected and advantageous use in food. Specifically, lipedoside B-IIIb, ligurobustoside C, ligurobustoside E, (2R,3R,4R,5R,6S)-6-((3,7-dimethylocta-1,6-dien-3-yl)oxy)-5-hydroxy-2-(hydroxymethyl)-4-(((2S,3R,4R,5R,6S)-3,4,5-trihydroxy-6-methyltetrahydro-2H-pyran-2-yl)oxy)tetrahydro-2H-pyran-3-yl (E)-3-(3,4-dihydroxyphenyl)acrylate (“CPD5”), a salt thereof or a mixture thereof has been found to enhance the sweetness of sweetness modifiers without undesirable off-notes.

In particular, lipedoside B-IIIb, ligurobustoside E, a salt thereof or a mixture thereof has been found to enhance the sweetness of sweetness modifiers without undesirable off-notes. Accordingly, the present invention provides a method of using lipedoside B-IIIb, ligurobustoside E, a salt thereof or a mixture thereof to enhance the sweetness of a sweetness modifier and decrease the amount of a sweetness modifier used in a consumable.

Compounds of the present invention are available commercially (for example, Biopurify Phytochemicals Ltd., China) and can also be isolated and purified form botanical extract such as, for example, Ligustrum robustum (Roxb.) Blume, which is also known as Ligustrum robustum, Phillyrea robusta Roxb., Olea robusta (Roxb.) Sweet, Visiania robusta (Roxb.) DC., Ligustrum purpurascens, Ligustrum expansum, mao dong qing tea or broadleaf holly. Ligustrum robustum (Roxb.) Blume is widely grown in the southwest region of China and has long been used as traditional health tea named Ku-Ding-Cha. Its extract has been reported to possess inhibitory effect on acyl coenzyme A:cholesterol acyltransferase (ACAT) enzyme and is therefore proposed to be useful in decreasing cholesterol level (Fukuda, et al., Chemical & Pharmaceutical Bulletin (1996), 44(11): 2173-2176). Ligustrum robustum extract has also been reported to possess antioxidant activity (He, et al., Journal of Natural Products (2003), 66(6): 851-854).

If provided as a Ligustrum robustum (Roxb.) Blume extract, specifically a leaf extract, it is enriched for lipedoside B-IIIb and/or ligurobustoside E to achieve a content of about 0.01% and greater, respectively. For example, the Ligustrum robustum (Roxb.) Blume extract leaf extract contains each of lipedoside B-IIIb and ligurobustoside E from about 0.01% to about 95%, from about 0.05% to about 50% or from about 0.1% to about 10%. Unless otherwise specified, percentages (% s) are by weight.

A natural sweetener includes, for example, but not limited to, sucrose, fructose, glucose, high fructose corn syrup, Stevia rebaudiana compositions including pure components of Reb A, stevioside, and rebaudioside D (Reb D), xylose, arabinose, or rhamnose, as well as sugar alcohols such as erythritol, xylitol, mannitol, sorbitol, inositol and a combination thereof. An artificial sweetener includes, for example, but not limited to, aspartame, sucralose, neotame, acesulfame potassium, saccharin and a combination thereof.

A flavoring is a preparation that provides a consumable with a particular taste and/or smell. A flavoring with modifying properties is a subset of the flavoring. It is added to the consumable to reduce off-notes and/or improve overall profile. The flavorings with modifying properties of the present invention include, for example, but not limited to, a stevia composition including stevioside, steviolbioside Reb A, rebaudioside B (Reb B), rebaudioside C (Reb C), Reb D, rebaudioside E (Reb E), rebaudioside F (Reb F), dulcoside A, dulcoside B, rubusoside, alpha-glucosyl stevia, fructosyl stevia, galactosyl stevia, beta-glucosyl stevia, siamenoside, mogroside IV, mogroside V, Luo Han Guo, monatin, glycyrrhizic acid, thaumatin, a salt thereof, a glycosylated derivative thereof and a combination thereof. The glycosylated derivatives can be prepared via transglycosylation reactions with, for example, but not limited to, glucose, fructose, galactose, rhamnose, ribose, mannose, arabinose, fucose, maltose, lactose, sucrose, rutinose, sorbose, xylulose, ribulose, rhamnulose and xylose. In one embodiment, the flavorings with modifying properties of the present invention include Reb A, Reb C, rubusoside, Reb D, mogroside V, Luo Han Guo, monatin acid, a salt thereof, a glycosylated derivative thereof and a combination thereof. The flavorings with modifying properties of the present invention exhibit weak intrinsic sweetness. Some other flavorings of the present invention include, for example, but not limited to, curculin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I and a combination thereof.

Accordingly, the term “a sweetness modifier” of the present invention refers to a sweetener including a natural sweetener and an artificial sweetener or a flavoring with modifying properties set forth in the above.

The term “sweetness” or “sweetness intensity” is understood to mean the relative strength of sweet sensation as observed or experienced by an individual, e.g., a human, or a degree or amount of sweetness detected by a taster, for example on the scale from 0 (none) to 8 (very strong) used in sensory evaluations according to the procedure described in American Society for Testing Materials, Special Technical Publication-434: “Manual on Sensory Testing Methods,” ASTM International, West Conshohocken, PA. (1996).

The term “olfactory effective amount” is understood to mean the amount of lipedoside B-IIIb, ligurobustoside E, a salt thereof or a mixture thereof used in a combination with a sweetness modifier, wherein lipedoside B-IIIb, ligurobustoside E, a salt thereof or a mixture thereof enhances the sweetness of the sweetness modifier. Its olfactory effective amount may vary depending on many factors including other ingredients, their relative amounts and the olfactory effect that is desired. Any amount of lipedoside B-IIIb, ligurobustoside E, a salt thereof or a mixture thereof that provides the desired degree of sweetness enhancement without exhibiting off-taste can be used. In certain embodiments, the olfactory effective amount ranges from about 1 ppb to about 1000 ppm by weight, preferably from about 2 ppb to about 100 ppm by weight and more preferably from about 5 ppb to about 10 ppm by weight. When used in the form of a botanical extract such as a Ligustrum robustum (Roxb.) Blume leaf extract, the olfactory effective amount ranges from about 100 ppb to about 5000 ppm by weight, preferably from about 1 to about 2000 ppm by weight and more preferably from about 10 to about 1000 ppm.

A consumable includes, for example, a food product (e.g., a beverage), a sweetener such as a natural sweetener or an artificial sweetener, a pharmaceutical composition, a dietary supplement, a nutraceutical, a dental hygienic composition and a cosmetic product. The consumable may further contain a flavoring.

In some embodiments, a consumable is a food product including, for example, but not limited to, fruits, vegetables, juices, meat products such as ham, bacon and sausage, egg products, fruit concentrates, gelatins and gelatin-like products such as jams, jellies, preserves and the like, milk products such as yogurt, ice cream, sour cream and sherbet, icings, syrups including molasses, corn, wheat, rye, soybean, oat, rice and barley products, nut meats and nut products, cakes, cookies, confectionaries such as candies, gums, fruit flavored drops, and chocolates, chewing gums, mints, creams, pies and breads. In a certain embodiment, the food product is a beverage including, for example, but not limited to, coffee, tea, carbonated soft drinks, such as COKE and PEPSI, non-carbonated soft drinks and other fruit drinks, sports drinks such as GATORADE and alcoholic beverages such as beers, wines and liquors. A consumable also includes prepared packaged products, such as granulated flavor mixes, which upon reconstitution with water provide non-carbonated drinks, instant pudding mixes, instant coffee and tea, coffee whiteners, malted milk mixes, pet foods, livestock feed, tobacco, and materials for baking applications, such as powdered baking mixes for the preparation of breads, cookies, cakes, pancakes, donuts and the like. A consumable also includes diet or low-calorie food and beverages containing little or no sucrose. A preferred consumable includes carbonated beverages. Consumables further include condiments such as herbs, spices and seasonings, flavor enhancers (e.g., monosodium glutamate), dietetic sweeteners and liquid sweeteners.

In other embodiments, a consumable is a pharmaceutical composition, a dietary supplement, a nutraceutical, a dental hygienic composition or a cosmetic product. Preferred compositions are pharmaceutical compositions containing lipedoside B-IIIb, ligurobustoside E, a salt thereof or a mixture thereof, one or more pharmaceutically acceptable excipients, and one or more active agents that exert a biological effect other than sweetness enhancement. Such active agents include pharmaceutical and biological agents that have an activity other than taste enhancement. Such active agents are well known in the art (See, e.g., The Physician's Desk Reference). Such compositions can be prepared according to procedures known in the art, for example, as described in Remington's Pharmaceutical Sciences, Mack Publishing Co., Easton, PA. In one embodiment, such an active agent includes a bronchodilator, an anorexiant, an antihistamine, a nutritional supplement, a laxative, an analgesic, an anesthetic, an antacid, a H2-receptor antagonist, an anticholinergic, an antidiarrheal, a demulcent, an antitussive, an antinauseant, an antimicrobial, an antibacterial, an antifungal, an antiviral, an expectorant, an anti-inflammatory agent, an antipyretic and a mixture thereof. In another embodiment, the active agent is selected from the group consisting of an antipyretic and analgesic, e.g., ibuprofen, acetaminophen or aspirin, a laxative, e.g., phenolphthalein dioctyl sodium sulfosuccinate, an appetite depressant, e.g., an amphetamine, phenylpropanolamine, phenylpropanolamine hydrochloride, or caffeine, an antacid, e.g., calcium carbonate, an antiasthmatic, e.g., theophylline, an antidiarrheal, e.g., diphenoxylate hydrochloride, an agent against flatulence, e.g., simethecon, a migraine agent, e.g., ergotamine tartrate, a psychopharmacological agent, e.g., haloperidol, a spasmolytic or sedative, e.g., phenobarbital, an antihyperkinetic, e.g., methyldopa or methylphenidate, a tranquilizer, e.g., a benzodiazepine, hydroxyzine, meprobramate or phenothiazine, an antihistaminic, e.g., astemizol, chlorpheniramine maleate, pyridamine maleate, doxlamine succinate, brompheniramine maleate, phenyltoloxamine citrate, chlorcyclizine hydrochloride, pheniramine maleate, or phenindamine tartrate, a decongestant, e.g., phenylpropanolamine hydrochloride, phenylephrine hydrochloride, pseudoephedrine hydrochloride, pseudoephedrine sulfate, phenylpropanolamine bitartrate, or ephedrine, a beta-receptor blocker, e.g., propranolol, an agent for alcohol withdrawal, e.g., disulfuram, an antitussive, e.g., benzocaine, dextromethorphan, dextromethorphan hydrobromide, noscapine, carbetapentane citrate, and chlophedianol hydrochloride, a fluorine supplement, e.g., sodium fluoride, a local antibiotic, e.g., tetracycline or clindamycin, a corticosteroid supplement, e.g., prednisone or prednisolone; an agent against gout, e.g., colchicine or allopurinol, an antiepileptic, e.g., phenytoin sodium, an agent against dehydration, e.g., electrolyte supplements, an antiseptic, e.g., cetylpyridinium chloride, a NSAID, e.g., acetaminophen, ibuprofen, naproxen, or a salt thereof, a gastrointestinal active agent, e.g., loperamide and famotidine, an alkaloid, e.g., codeine phosphate, codeine sulfate, or morphine, a supplement for trace elements, e.g., sodium chloride, zinc chloride, calcium carbonate, magnesium oxide, and other alkali metal salts and alkali earth metal salts; a vitamin, an ion-exchange resin, e.g., cholestyramine, a cholesterol-depressant and lipid-lowering substance, an antiarrhythmic, e.g., N-acetylprocainamide and an expectorant, e.g., guaifenesin. Examples of dietary supplements or nutraceuticals include, for example, but are not limited to, an enteral nutrition product for treatment of nutritional deficit, trauma, surgery, Crohn's disease, renal disease, hypertension, obesity and the like, to promote athletic performance, muscle enhancement or general well-being or inborn errors of metabolism such as phenylketonuria. In particular, such compositions can contain one or more amino acids which have a bitter or metallic taste or aftertaste. Such amino acids include, for example, but are not limited to, an essential amino acid such as L isomers of leucine, isoleucine, histidine, lysine, methionine, phenylalanine, threonine, tryptophan, tyrosine and valine. Dental hygienic compositions are known in the art and include, for example, but not limited to, a toothpaste, a mouthwash, a plaque rinse, a dental floss, a dental pain reliever (such as ANBESOL) and the like. In one embodiment, the dental hygienic composition includes one natural sweetener. In another embodiment, the dental hygienic composition includes more than one natural sweetener. In yet another embodiment, the dental hygienic composition includes sucrose and corn syrup, or sucrose and aspartame. A cosmetic product includes, for example, but not limited to, a face cream, a lipstick, a lip gloss and the like. Other suitable cosmetic products of use in this invention include a lip balm, such as CHAPSTICK or BURTS BEESWAX Lip Balm.

In addition, the present invention also provides methods for enhancing the sweetness of a flavoring with modifying properties and decreasing its use level in a consumable by incorporating lipedoside B-IIIb, ligurobustoside E, a salt thereof or a mixture thereof. In one embodiment, the invention provides a consumable containing an olfactory effective amount of lipedoside B-IIIb, ligurobustoside E, a salt thereof or a mixture thereof and a flavoring with modifying properties in a reduced amount in order to achieve the same level of sweetness when the flavoring with modifying properties is used alone in a traditional amount. In this respect, the amount of flavoring with modifying properties used in a consumable can be reduced by at least about 10%, 20%, 30%, 40%, 50%, 60%, 70%, 80%, 90%, or 95%, from about 60% to about 99% or from about 20% to about 50%.

As indicated, lipedoside B-IIIb, ligurobustoside E, a salt thereof or a mixture thereof can be used in a consumable as a sweetness enhancer, which retains a desired sweetness but contains lower amounts of a natural sweetener or an artificial sweetener. For example, an improved carbonated soft drink can be produced with the same sweetness as the known carbonated soft drink but with lower sugar content by adding lipedoside B-IIIb, ligurobustoside E, a salt thereof or a mixture thereof.

Additional materials can also be used in conjunction with lipedoside B-IIIb, ligurobustoside E, a salt thereof or a mixture thereof of the present invention to encapsulate and/or deliver the lingering aftertaste masking effect. Some well-known materials are, for example, but not limited to, polymers, oligomers, other non-polymers such as surfactants, emulsifiers, lipids including fats, waxes and phospholipids, organic oils, mineral oils, petrolatum, natural oils, perfume fixatives, fibers, starches, sugars and solid surface materials such as zeolite and silica. Some preferred polymers include polyacrylate, polyurea, polyurethane, polyacrylamide, polyester, polyether, polyamide, poly(acrylate-co-acrylamide), starch, silica, gelatin and gum arabic, alginate, chitosan, polylactide, poly(melamine-formaldehyde), poly(urea-formaldehyde), or a combination thereof.

The following are provided as specific embodiments of the present invention. Other modifications of this invention will be readily apparent to those skilled in the art. Such modifications are understood to be within the scope of this invention. Materials were purchased from Aldrich Chemical Company unless noted otherwise. As used herein all percentages are weight percent unless otherwise noted, ppm is understood to stand for parts per million, L is understood to be liter, mL is understood to be milliliter, g is understood to be gram, Kg is understood to be kilogram, mol is understood to be mole, mmol is understood to be millimole, psig is understood to be pound-force per square inch gauge, and mmHg be millimeters (mm) of mercury (Hg). IFF as used in the examples is understood to mean International Flavors & Fragrances Inc., New York, NY, USA.

### Example I: Preparation of Glucopyranoside Compounds

A Ligustrum robustum (Roxb.) Blume leaf extract was prepared in water and/or ethanol according to a method known to a skilled person (WO 2020/118002).

Lipedoside B-IIIb, ligurobustoside E, ligurobustoside C, (2R,3R,4R,5R,6S)-6-((3,7-dimethylocta-1,6-dien-3-yl)oxy)-5-hydroxy-2-(hydroxymethyl)-4-(((2S,3R,4R,5R,6S)-3,4,5-trihydroxy-6-methyltetrahydro-2H-pyran-2-yl)oxy)tetrahydro-2H-pyran-3-yl (E)-3-(3,4-dihydroxyphenyl)acrylate (“CPD5”), ligurobustoside K and (2R,3R,4R,5R,6R)-6-(((E)-3,7-dimethyl-5-oxoocta-3,6-dien-1-yl)oxy)-5-hydroxy-2-(hydroxymethyl)-4-(((2S,3R,4R,5R,6S)-3,4,5-trihydroxy-6-methyltetrahydro-2H-pyran-2-yl)oxy)tetrahydro-2H-pyran-3-yl (E)-3-(4-hydroxyphenyl)acrylate (“CPD6”) were each isolated and respective structures were elucidated by analyzing high resolution LCMS, UV absorbance and proton and carbon NMR spectra.

Water solutions of exemplary compounds including lipedoside B-IIIb, ligurobustoside E and ligurobustoside K were each prepared and evaluated at 1, 2 and 5 ppm, respectively. All were devoid of taste and smell except ligurobustoside E, which displayed slight astringency at 5 ppm.

### Example II: Sweetness Enhancement of Sucrose

A sucrose solution (6%) was prepared in water and used as the base solution. Sucrose solutions of lipedoside B-IIIb, ligurobustoside E, ligurobustoside C, CPD5, ligurobustoside K ligurobustoside I and CPD6 were each prepared at 0.1-2 ppm. Flavor profiles of the sucrose solutions with added lipedoside B-IIIb, ligurobustoside E, ligurobustoside C, CPD5, ligurobustoside K and CPD6 are reported in the following:

| Compound | Concentration | Flavor Profile |
|---|---|---|
| Lipedoside B-IIIb | 0.1 | Slight sweetness enhancement, lingering sweetness |
| Lipedoside B-IIIb | 1 | Sweetness enhancement, lingering sweetness |
| Lipedoside B-IIIb | 2 | Strong upfront sweetness and sugary mouthfeel |
| Ligurobustoside E | 0.1 | Sweetness enhancement, lingering sweetness |
| Ligurobustoside E | 1 | Upfront sweetness, lingering sweetness |
| Ligurobustoside E | 2 | Strong sweetness enhancement, strong impact with |
| | | sugary mouthfeel |
| Ligurobustoside C | 2 | Some upfront sweetness and mouthfeel enhancement |
| CPD5 | 2 | Moderate sweetness and mouthfeel enhancement |
| Ligurobustoside K | 2 | Weak sweetness and mouthfeel enhancement |
| ligurobustoside I | 2 | Weak sweetness and mouthfeel enhancement |
| CPD6 | 2 | Weak lingering sweetness and mouthfeel enhancement |

Lipedoside B-IIIb and ligurobustoside E provided particularly strong sweetness and sugary mouthfeel enhancement and are suitable for flavor use.

### Example III: Sweetness Enhancement of Additional Sweetness Modifiers

Base solutions of additional sweetness modifiers including Luo Han Guo (“LHG”) (Biovittoria Ltd., New Zealand) (120 ppm), Reb A (200 ppm), sucralose (“SUR”) (100 ppm) and aspartame (“ASP”) (500 ppm) were prepared in water. The flavor profiles of these base solutions with added lipedoside B-IIIb and ligurobustoside E are reported in the following:

| | Lipedoside B-IIIb (ppm) | | | Ligurobustoside E (ppm) | | |
|---|---|---|---|---|---|---|
| | 0.1 | 0.5 | 1 | 0.1 | 0.5 | 1 |
| LHG | Slightly | Sweeter, | Sharp sweetness, | Slightly | Sweeter, | Sharp sweetness, |
| | enhanced | sugary | honey-like mouthfeel, | enhanced | sugary | honey-like mouthfeel, |
| | sweetness | mouthfeel | less off-notes | sweetness | mouthfeel | less off-notes |
| Reb A | Slightly | Sweeter, less | Sharp sweetness, | Slightly | Sweeter, less | Sharp sweetness, |
| | enhanced | lingering | enhanced mouthfeel, | enhanced | lingering | enhanced mouthfeel, |
| | sweetness | aftertaste | less lingering | sweetness | aftertaste | less lingering |
| | | | aftertaste, less off- | | | aftertaste, less off- |
| | | | notes | | | notes |
| SUR | Slightly | Sweeter, | Sharp sweetness, | Slightly | Sweeter, | Upfront sweetness, |
| | enhanced | sugary | enhanced mouthfeel, | enhanced | sugary | honey-like mouthfeel, |
| | sweetness | mouthfeel | less lingering | sweetness | mouthfeel, | more sugary |
| | | | aftertaste | | less | mouthfeel |
| | | | | | lingering | |
| | | | | | aftertaste | |
| ASP | Slightly | Sweeter, | Sharp sweetness, | Slightly | Sweeter, | Sharp sweetness, |
| | enhanced | sugary | more sugary | enhanced | sugary | honey-like mouthfeel, |
| | sweetness | mouthfeel | mouthfeel, less off- | sweetness | mouthfeel, | less off-notes |
| | | | notes | | less | |
| | | | | | lingering | |
| | | | | | aftertaste | |

### Example IV: Preparation and Evaluation of Lipedoside b-IIIb and Ligurobustoside E Mixtures of Different Ratios

A series of sucrose solutions (6%) containing lipedoside B-IIIb (“B-IIIb”) and ligurobustoside E (“E”) mixtures of different weight ratios (“Ratio”) were prepared. The sucrose base solution was used as the control. Flavor profiles of solution samples were subsequently compared with the control by a group of panelists and are reported as follows:

| | B-IIIb | E | | B-IIIb + E | |
|---|---|---|---|---|---|
| Sample | (ppm) | (ppm) | Ratio | (ppm) | Flavor Profile |
| 1 | 0.00001 | 0.00099 | 0.01 | 0.001 | Similar to the control |
| 2 | 0.0001 | 0.0099 | | 0.01 | Similar to the control |
| 3 | 0.0005 | 0.0495 | | 0.05 | Similar to the control |
| 4 | 0.005 | 0.495 | | 0.5 | Similar to the control |
| 5 | 0.091 | 0.909 | | 1 | Similar to the control |
| 6 | 0.909 | 9.091 | | 10 | Slightly sweeter |
| 7 | 0.248 | 24.752 | | 25 | slightly sweeter with astringency |
| 8 | 0.00009 | 0.00091 | 0.1 | 0.001 | Similar to the control |
| 9 | 0.0009 | 0.0091 | | 0.01 | Similar to the control |
| 10 | 0.0045 | 0.0455 | | 0.05 | Similar to the control |
| 11 | 0.045 | 0.455 | | 0.5 | Similar to the control |
| 12 | 0.091 | 0.909 | | 1 | Similar to the control |
| 13 | 0.909 | 9.091 | | 10 | Slightly sweeter with some off-notes |
| 14 | 2.272 | 22.728 | | 25 | Slightly sweeter with some off-notes, |
| | | | | | astringent |
| 15 | 0.00017 | 0.00083 | 0.2 | 0.001 | Slightly sweeter |
| 16 | 0.0017 | 0.0083 | | 0.01 | Sweeter |
| 17 | 0.0083 | 0.0417 | | 0.05 | Sweeter |
| 18 | 0.083 | 0.417 | | 0.5 | Sweeter |
| 19 | 0.167 | 0.833 | | 1 | Sharp sweetness, enhanced mouthfeel |
| 20 | 1.667 | 8.333 | | 10 | Sharp sweetness with a little plastic-like |
| | | | | | off-note |
| 21 | 4.167 | 20.833 | | 25 | Sharp sweetness |
| 22 | 0.00033 | 0.00067 | 0.5 | 0.001 | Slightly sweeter |
| 23 | 0.0033 | 0.0067 | | 0.01 | Sweeter |
| 24 | 0.0167 | 0.0333 | | 0.05 | Sweeter, sugary mouthfeel |
| 25 | 0.167 | 0.333 | | 0.5 | Sweeter, sugary mouthfeel |
| 26 | 0.333 | 0.667 | | 1 | Sweeter, sugary mouthfeel |
| 27 | 3.333 | 6.667 | | 10 | Sharp sweetness, honey-like mouthfeel |
| 28 | 8.333 | 16.667 | | 25 | Sharp sweetness, honey-like mouthfeel |
| 29 | 0.0005 | 0.0005 | 1 | 0.001 | Slightly sweeter |
| 30 | 0.005 | 0.005 | | 0.01 | Sweeter |
| 31 | 0.025 | 0.025 | | 0.05 | Sweeter, sugary mouthfeel |
| 32 | 0.25 | 0.25 | | 0.5 | Sweeter, sugary mouthfeel |
| 33 | 0.5 | 0.5 | | 1 | Sharp sweetness, honey-like mouthfeel |
| 34 | 5 | 5 | | 10 | Sharp sweetness, honey-like mouthfeel |
| 35 | 12.5 | 12.5 | | 25 | Sharp sweetness, honey-like mouthfeel |
| 36 | 0.00067 | 0.00033 | 2 | 0.001 | Slightly sweeter |
| 37 | 0.0067 | 0.0033 | | 0.01 | Sweeter |
| 38 | 0.0333 | 0.0167 | | 0.05 | Sweeter, sugary mouthfeel |
| 39 | 0.333 | 0.167 | | 0.5 | Sweeter, sugary mouthfeel |
| 40 | 0.667 | 0.333 | | 1 | Sharp sweetness, honey-like mouthfeel |
| 41 | 6.667 | 3.333 | | 10 | Sharp sweetness, honey-like mouthfeel |
| 42 | 8.333 | 16.667 | | 25 | Sharp sweetness, honey-like mouthfeel |
| 43 | 0.00083 | 0.00017 | 5 | 0.001 | Slightly sweeter |
| 44 | 0.0083 | 0.0017 | | 0.01 | Sweeter |
| 45 | 0.0417 | 0.0083 | | 0.05 | Sweeter, sugary mouthfeel |
| 46 | 0.417 | 0.083 | | 0.5 | Sweeter, sugary mouthfeel |
| 47 | 0.833 | 0.167 | | 1 | Sharp sweetness, honey-like mouthfeel |
| 48 | 8.333 | 1.667 | | 10 | Sharp sweetness, honey-like mouthfeel |
| 49 | 20.833 | 4.167 | | 25 | Sharp sweetness, honey-like mouthfeel |
| 50 | 0.00091 | 0.00009 | 10 | 0.001 | Slightly sweeter |
| 51 | 0.0091 | 0.0009 | | 0.01 | Slightly sweeter |
| 52 | 0.0455 | 0.0045 | | 0.05 | Sweeter |
| 53 | 0.455 | 0.045 | | 0.5 | Sweeter, sugary mouthfeel |
| 54 | 0.909 | 0.091 | | 1 | Sweeter |
| 55 | 9.091 | 0.909 | | 10 | Sharp sweetness |
| 56 | 22.728 | 2.272 | | 25 | Sharp sweetness |
| 57 | 0.00093 | 0.00007 | 13 | 0.001 | Slightly sweeter |
| 58 | 0.0093 | 0.0007 | | 0.01 | Slightly sweeter |
| 59 | 0.0464 | 0.0036 | | 0.05 | Sweeter |
| 60 | 0.464 | 0.036 | | 0.5 | Sweeter, sugary mouthfeel |
| 61 | 0.929 | 0.071 | | 1 | Sweeter, sugary mouthfeel |
| 62 | 9.286 | 0.714 | | 10 | Sweeter |
| 63 | 23.214 | 1.786 | | 25 | Sweeter |
| 64 | 0.00094 | 0.00006 | 15 | 0.001 | Similar to the control |
| 65 | 0.0094 | 0.0006 | | 0.01 | Similar to the control |
| 66 | 0.0469 | 0.0031 | | 0.05 | Similar to the control |
| 67 | 0.469 | 0.031 | | 0.5 | Similar to the control |
| 68 | 0.938 | 0.062 | | 1 | Similar to the control |
| 69 | 9.375 | 0.625 | | 10 | Slightly sweeter with some off-notes |
| 70 | 23.438 | 1.562 | | 25 | Slightly sweeter with some off-notes, |
| | | | | | astringent |
| 71 | 0.00095 | 0.00005 | 20 | 0.001 | Similar to the control |
| 72 | 0.0095 | 0.0005 | | 0.01 | Similar to the control |
| 73 | 0.048 | 0.002 | | 0.05 | Similar to the control |
| 74 | 0.476 | 0.024 | | 0.5 | Similar to the control |
| 75 | 0.952 | 0.048 | | 1 | Similar to the control |
| 76 | 9.523 | 0.476 | | 10 | Slightly sweeter with some off-notes |
| 77 | 23.810 | 1.190 | | 25 | Slightly sweeter with some off-notes, |
| | | | | | astringent |

### Example IV (Continued)

The above evaluation yielded unexpected finding, samples 15-63 were surprisingly superior to samples 1-14 and 64-77. There was criticality to the mixing ratios of lipedoside B-IIIb and ligurobustoside E. Specifically, only a mixture having a lipedoside B-IIIb and ligurobustoside E weight ratio of from about 0.2 to 13 was found to possess desirable sweetness enhancement and is suitable for flavor applications. A weight ratio outside the defined ranges caused insufficient sweetness enhancement and off-notes which rendered the lipedoside B-IIIb and ligurobustoside E mixture unsuitable for use in flavor applications. Thus, the present invention made surprising and unexpected discovery of the criticality of the weight ratios in lipedoside B-IIIb and ligurobustoside E mixture.

### Example V: Enhancement of Sucrose Sweetness by Botanical Extract

Ligustrum robustum (Roxb.) Blume leaf extract containing lipedoside B-IIIb (0.3%) and ligurobustoside E (0.1%) was obtained. Sucrose solutions (6%) with the addition of various amount of Ligustrum robustum (Roxb.) Blume leaf extract was evaluated. The flavor profile is as follows:

| Sample | Extract (ppm) | Flavor Profile |
|---|---|---|
| 1 | 0 (Base) | Mild in sweet perception |
| 2 | 1 | Very slight sweetness enhancement and perception of sugary |
| | | mouthfeel |
| 3 | 10 | Slightly sweeter, natural fruit juice-like taste |
| 4 | 20 | Sweeter, honey-like mouthfeel |
| 5 | 50 | Enhanced and lasting sweetness, sugary mouthfeel |
| 6 | 100 | Upfront sweetness, sugary mouthfeel |
| 7 | 200 | Upfront and fruity sweetness, sugary and honey-like mouthfeel |
| 8 | 500 | Upfront sweetness, more fruity aroma, slightly botanical, mouth- |
| | | coating |
| 9 | 1000 | Upfront sweetness, fruity aroma, botanical, slightly astringent |
| 10 | 1500 | Off-taste and astringent note started to develop |
| 11 | 2000 | More off-taste and astringent note |

Ligustrum robustum (Roxb.) Blume leave extract enhanced sucrose sweetness and mouthfeel starting at 1 ppm. However, undesirable off-taste started to develop at 1500 ppm.

### Example VI: Enhancement of Luo Han Guo Sweetness by Botanical Extract

Luo Han Guo solution (120 ppm) with the addition of various amount of Ligustrum robustum (Roxb.) Blume leave extract was evaluated. The flavor profile is as follows:

| Sample | Extract (ppm) | Flavor Profile |
|---|---|---|
| 1 | 0 (Base) | Mild in sweet perception |
| 2 | 1 | Very slight sweetness enhancement and perception of sugary |
| | | mouthfeel |
| 3 | 10 | Slightly sweeter, enhanced mouthfeel, less off-notes |
| 4 | 20 | Sweeter, honey-like mouthfeel |
| 5 | 50 | Enhanced sweetness, sugary mouthfeel, less lingering aftertaste, less |
| | | off-notes |
| 6 | 100 | Upfront sweetness, sugary mouthfeel, less off-notes |
| 7 | 200 | Strong upfront sweetness, more sucrose-like mouthfeel, less off- |
| | | notes |
| 8 | 500 | Upfront sweetness, fruity aroma, slightly botanical |
| 9 | 1000 | Upfront sweetness, more botanical, started to display off-taste, |
| | | slightly astringent |
| 10 | 1500 | More off-taste and astringent note, started to overpower sweetness |
| 11 | 2000 | More botanical off-taste and astringent note, overpowered |
| | | sweetness, woody and barky |

Ligustrum robustum (Roxb.) Blume leave extract provided sucrose-like flavor profile.

Ligustrum robustum (Roxb.) Blume leave extract enhanced Luo Han Guo sweetness and masked lingering bitterness. However, undesirable off-taste started to develop at 1500 ppm.

### Example VII: Enhancement of Reb A Sweetness by Botanical Extract

The Reb A solution (200 ppm) with the addition of various amount of Ligustrum robustum (Roxb.) Blume leave extract was evaluated. The flavor profile is as follows:

| Sample | Extract (ppm) | Flavor Profile |
|---|---|---|
| 1 | 0 (Base) | Mild in sweet perception, lingering aftertaste |
| 2 | 1 | Very slight sweetness enhancement |
| 3 | 10 | Slight sweetness enhancement and perception of sugary mouthfeel |
| 4 | 20 | Sweeter, honey-like mouthfeel, less off-notes |
| 5 | 50 | Enhanced sweetness, sugary mouthfeel, less off-notes |
| 6 | 100 | Upfront sweetness, sugary mouthfeel, less lingering aftertaste, less |
| | | off-notes |
| 7 | 200 | Upfront and fruity sweetness, honey-like mouthfeel |
| 8 | 500 | Upfront sweetness, more fruity aroma, slightly botanical, mouth- |
| | | coating |
| 9 | 1000 | Upfront sweetness, fruity, more botanical, slightly astringent |
| 10 | 1500 | More off-taste and astringent note, started to overpower sweetness |
| 11 | 2000 | More botanical off-taste and astringent note, overpowered sweetness |

Ligustrum robustum (Roxb.) Blume leave extract enhanced Reb A sweetness and mouthfeel, and masked lingering bitterness and off-taste. However, undesirable off-taste started to develop at 1500 ppm.

### Example VIII: Enhancement of Sucralose Sweetness by Botanical Extract

The sucralose solution (100 ppm) with the addition of various amount of Ligustrum robustum (Roxb.) Blume leave extract was evaluated. The flavor profile is as follows:

| Sample | Extract (ppm) | Flavor Profile |
|---|---|---|
| 1 | 0 (Base) | Mild in sweet perception, lingering aftertaste |
| 2 | 1 | Very slight sweetness enhancement and perception of sugary |
| | | mouthfeel |
| 3 | 10 | Slightly sweeter, sugary mouthfeel |
| 4 | 20 | Sweeter, honey-like mouthfeel |
| 5 | 50 | Upfront sweetness, sugary mouthfeel, less lingering aftertaste |
| 6 | 100 | Upfront sweetness, sugary mouthfeel |
| 7 | 200 | Upfront and fruity sweetness, sugary and honey-like mouthfeel |
| 8 | 500 | Upfront sweetness, more fruity aroma, slightly botanical, mouth- |
| | | coating |
| 9 | 1000 | Upfront sweetness, fruity, more botanical, some astringent |
| 10 | 1500 | More off-taste and astringent note, started to overpower sweetness |
| 11 | 2000 | More botanical off-taste and astringent note, overpowered |
| | | sweetness, woody and barky |

Ligustrum robustum (Roxb.) Blume leave extract enhanced sucralose sweetness and mouthfeel, and masked lingering bitterness and off-taste. However, undesirable off-taste started to develop at 1500 ppm.

### Example VIII: Enhancement of Aspartame Sweetness by Botanical Extract

The aspartame solution (500 ppm) with the addition of various amount of Ligustrum robustum (Roxb.) Blume leave extract was evaluated. The flavor profile is as follows:

| Sample | Extract (ppm) | Flavor Profile |
|---|---|---|
| 1 | 0 (Base) | Mild in sweet perception, lingering |
| 2 | 1 | Very slight sweetness enhancement and perception of sugary |
| | | mouthfeel |
| 3 | 10 | Slightly sweeter, enhanced mouthfeel |
| 4 | 20 | Sweeter, honey-like mouthfeel |
| 5 | 50 | Upfront sweetness, sugary mouthfeel, less lingering aftertaste |
| 6 | 100 | Upfront sweetness, sugary mouthfeel, less lingering aftertaste |
| 7 | 200 | Upfront and fruity sweetness, sugary and honey-like mouthfeel, less |
| | | off-notes |
| 8 | 500 | Upfront sweetness, more fruity aroma, slightly botanical, mouth- |
| | | coating |
| 9 | 1000 | Upfront sweetness, fruity, more botanical, astringent |
| 10 | 1500 | More off-taste and astringent note, started to overpower sweetness |
| 11 | 2000 | More botanical off-taste and astringent note, overpowered |
| | | sweetness, woody and barky |

Ligustrum robustum (Roxb.) Blume leave extract enhanced aspartame sweetness and mouthfeel, and masked lingering bitterness and off-taste. However, undesirable off-taste started to develop at 1500 ppm.

What is claimed is:

1. A method of enhancing the sweetness of a sweetness modifier comprising the step of adding an olfactory effective amount of a compound represented by Formula I to the sweetness modifier: 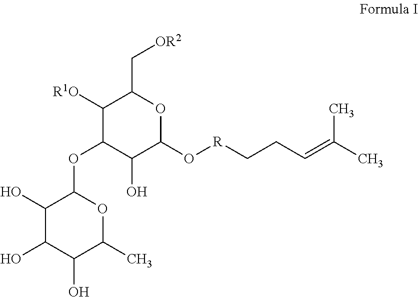
wherein one of R¹ and R² represents hydrogen and the other one thereof represents 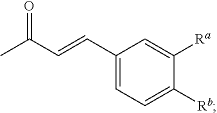
R^{a} and R^{b} are independently selected from the group consisting of hydrogen and a hydroxy group; and wherein R represents a C₄ alkenyl group.

2. The method of claim 1, wherein the sweetness modifier is a sweetener.

3. The method of claim 2, wherein the sweetener is a natural sweetener selected from the group consisting of sucrose, fructose, glucose, high fructose corn syrup, rebaudioside A, stevioside, rebaudioside D, xylose, arabinose, rhamnose, erythritol, xylitol, mannitol, sorbitol, inositol and a combination thereof.

4. The method of claim 2, wherein the sweetener is an artificial sweetener selected from the group consisting of aspartame, sucralose, neotame, acesulfame potassium, saccharin and a combination thereof.

5. The method of claim 1, wherein the sweetness modifier is a flavoring with modifying properties selected from the group consisting of stevioside, steviolbioside rebaudioside A, rebaudioside B, rebaudioside C, rebaudioside D, rebaudioside E, rebaudioside F, dulcoside A, dulcoside B, rubusoside, alpha-glucosyl stevia, fructosyl stevia, galactosyl stevia, beta-glucosyl stevia, siamenoside, mogroside IV, mogroside V, Luo Han Guo, monatin, glycyrrhizic acid, thaumatin, a salt thereof, a glycosylated derivative thereof and a combination thereof.

6. The method of claim 1, wherein the olfactory effective amount is from about 1 ppb to about 1000 ppm.

7. The method of claim 1, wherein the compound is selected from the group consisting of lipedoside B-IIa; lipedoside B-IIb; lipedoside B-IIIa; lipedoside B-IIIb; β-D-glucopyranoside, 1-ethenyl-1,5-dimethyl-4-hexenyl 3-O-(6-deoxy-α-L-mannopyranosyl)-, 4-[(2E)-3-(4-hydroxyphenyl)-2-propenoate]; ligurobustoside E; ligurobustoside C; ligurobustoside D; ligurobustoside B; and a mixture thereof.

8. The method of claim 7, wherein the compound is a mixture of lipedoside B-IIIb and ligurobustoside E, and wherein lipedoside B-IIIb and ligurobustoside E have a weight ratio of from about 0.2 to 13.

9. The method of claim 8, wherein the compound is provided as a Ligustrum robustum (Roxb.) Blume leaf extract; and wherein the olfactory effective amount is from about 100 ppb to about 5000 ppm.

10. A composition comprising a sweetness modifier and an olfactory effective amount of a compound represented by Formula I: 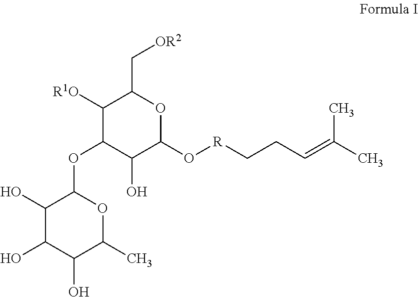
wherein one of R¹ and R² represents hydrogen and the other one thereof represents 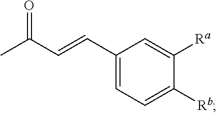
R^{a} and R^{b} are independently selected from the group consisting of hydrogen and a hydroxy group; and wherein R represents a C₄ alkenyl group.

11. The composition of claim 10, wherein the sweetness modifier is a sweetener.

12. The composition of claim 11, wherein the sweetener is a natural sweetener selected from the group consisting of sucrose, fructose, glucose, high fructose corn syrup, rebaudioside A, stevioside, rebaudioside D, xylose, arabinose, rhamnose, erythritol, xylitol, mannitol, sorbitol, inositol and a combination thereof.

13. The composition of claim 11, wherein the sweetener is an artificial sweetener selected from the group consisting of aspartame, sucralose, neotame, acesulfame potassium, saccharin and a combination thereof.

14. The composition of claim 10, wherein the sweetness modifier is a flavoring with modifying properties selected from the group consisting of stevioside, steviolbioside rebaudioside A, rebaudioside B, rebaudioside C, rebaudioside D, rebaudioside E, rebaudioside F, dulcoside A, dulcoside B, rubusoside, alpha-glucosyl stevia, fructosyl stevia, galactosyl stevia, beta-glucosyl stevia, siamenoside, mogroside IV, mogroside V, Luo Han Guo, monatin, glycyrrhizic acid, thaumatin, a salt thereof, a glycosylated derivative thereof and a combination thereof.

15. The composition of claim 10, wherein the olfactory effective amount is from about 1 ppb to about 1000 ppm.

16. The composition of claim 10, wherein the compound is selected from the group consisting of lipedoside B-IIa; lipedoside B-IIb; lipedoside B-IIIa; lipedoside B-IIIb; β-D-glucopyranoside, 1-ethenyl-1,5-dimethyl-4-hexenyl 3-O-(6-deoxy-α-L-mannopyranosyl)-, 4-[(2E)-3-(4-hydroxyphenyl)-2-propenoate]; ligurobustoside E; ligurobustoside C; ligurobustoside D; ligurobustoside B; and a mixture thereof.

17. The composition of claim 16, wherein the compound is a mixture of lipedoside B-IIIb and ligurobustoside E, and wherein lipedoside B-IIIb and ligurobustoside E have a weight ratio of from about 0.2 to 13.

18. The composition of claim 17, wherein the compound is provided as a Ligustrum robustum (Roxb.) Blume leaf extract; and wherein the olfactory effective amount is from about 100 ppb to about 5000 ppm.

19. A consumable comprising a sweetness modifier and an olfactory effective amount of a compound represented by Formula I: 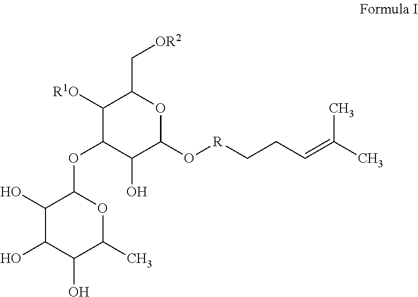
wherein one of R¹ and R² represents hydrogen and the other one thereof represents 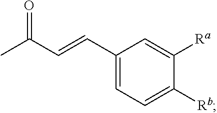
R^{a} and R^{b} are independently selected from the group consisting of hydrogen and a hydroxy group; and wherein R represents a C₄ alkenyl group.

20. The consumable of claim 19, wherein the consumable is a food product; the compound is provided as a Ligustrum robustum (Roxb.) Blume leaf extract; and wherein the olfactory effective amount is from about 100 ppb to about 5000 ppm.
